(19) United States
(12) Patent Application Publication
(10) Pub. No.: US 2006/0200710 A1
(43) Pub. Date: Sep. 7, 2006

(54) Bit error rate performance estimation and control

(75) Inventors: Stephen Michael Webb, Essex (GB); David Winterburn, Hertfordshire (GB); Stephen Desbruslais, London (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Azea Networks, Ltd., Romford (GB)

(21) Appl. No.: 11/072,861

(22) Filed: Mar. 4, 2005

(51) Int. Cl. G06F 11/00

(52) U.S. Cl. 714/704

(57) ABSTRACT

There is provided a method and system for obtaining an enhanced estimate of bit error rate performance. A receiver module counts a predetermined number of bit errors and concurrently measures the time taken for the predetermined number of bit errors to occur. In this way an estimate of the bit error rate (BER) is obtained which has the same statistical weight regardless of the numerical value of the BER. The estimate of BER can subsequently be used to optimise the parameters of the system such that the true value of BER is at a minimum.

### FIELD OF THE INVENTION

The present invention relates to a method for estimating bit error rate (BER) performance of transmission system and its use in applying statistically consistent feedback via a high-level control loop.

### BACKGROUND TO THE INVENTION

High-level adaptive control loops may be implemented to improve transmission on long haul optical systems. Typically many parameters may be adjusted and each will have an effect that may improve or degrade transmission depending on their adjustment direction. For example, in systems that employ wavelength-division multiplexing (WDM), relative channel powers may be adjusted to equalise channel performance.

These control loops often rely on bit error rate (BER) feedback from the receiver at the end of the transmission system and it can be cumbersome to maintain reliable and robust control. Existing control loop designs are often simplistic and become confused or make statistically incorrect decisions under certain circumstances. Many legacy equipment vendors do not trust them and often disable the function once a system is commissioned. This will eventually lead to degraded system performance, requiring a periodic re-tuning of the system parameters, and offers less overall margin within the system.

Typically, the BER is derived from an error counter register that may periodically be read and re-set. A simplistic algorithm may take this error counter reading at equal time intervals and derive a BER from it. The result is generally an estimate of a mean BER over the period of observation. However, such estimation techniques are not sufficiently consistent and, when used for feedback control of transmission system parameters, can lead to inappropriate decisions that move the system away from the optimum operating conditions.

There is therefore a need for a more robust method of estimating the bit error rate performance of a transmission system and which provides more consistent data for the purpose of controlling parameters of the transmission system via feedback loops in order to achieve optimal performance of the system.

### SUMMARY OF THE INVENTION

According to a first aspect of the present invention, a method for estimating the bit error performance of a transmission system through which a signal is propagating comprises the steps of:

counting a predetermined number of bit errors occurring sequentially in the signal;

concurrently recording a time period during which the predetermined number of bit errors occurs; and,

computing a measured bit error rate (BER) in dependence on the predetermined number of bit errors and the time period.

The above method provides a more consistent and statistically reliable measure of BER for characterising the bit error performance of a transmission system. Although the BER will be determined more quickly at high error rates and more slowly at low error rates, it will always have an equivalent statistical weight, in contrast to known techniques.

Preferably, the predetermined number of bit errors is at least 10. More preferably, the predetermined number is at least 100. Of course, a higher predetermined number will yield a BER to a higher degree of confidence and accuracy, but at the expense of an increased measurement time period.

The method may be applied to the signal in a continuous manner so that measurement time periods are consecutive. In this way, as soon as the predetermined number of bit errors has been counted the process is repeated to count the subsequent predetermined number of bit errors. Alternatively, when error rates are high, BER may be calculated on a periodic basis as long as the predetermined number of bit errors has been counted in the period and the period is such that the resulting frequency of BER measures is suitable for proper functioning of the control loop.

In this implementation, when error rates are high the system performance may be estimated at a fast but constant rate, but with increasingly accurate BER statistics for increasing error rate. When error rates are low, the system performance will be estimated at an increasingly slower rate for decreasing error rate, but with a BER of constant accuracy.

The measurement of bit errors may be obtained from the signal propagating through the transmission system in a number of ways. Typically, the bit errors are obtained from the signal received by a receiver of the transmission system.

Preferably, the bit errors are obtained by forward error correction (FEC) decoding of the received signal. An FEC decoder unit is often present in the receiver module of a transmission system and provides ready access to bit errors detected in the received signal. In the absence of FEC, errors can be counted using the overhead bytes of the transmission type. For example, error detecting codes contained in the B1 and B2 bytes of the SDH/SONET overhead can be used to estimate the BER.

According to a second aspect of the present invention, a method for controlling the bit error performance of a transmission system through which a signal is propagating comprises the steps of:

estimating the bit error performance of the transmission system according to the method of the first aspect of the present invention; and,

adjusting a parameter of the transmission system in dependence on the measured BER.

This aspect of the invention provides a method for adjusting a system parameter in dependence on a statistically consistent estimation of the BER performance of the system.

Preferably, the transmission system parameter is adjusted to reduce the measured BER. The step may then be repeated according to a particular control algorithm in order to achieve an optimum operating point where the BER is minimised with respect to the system parameter under control. Therefore, the method preferably comprises the step of providing a parameter control signal adjusting a parameter of the transmission system in dependence on the measured BER

According to a third aspect of the present invention a computer program product comprises computer executable code for implementing the method of the first or second aspects of the present invention.

As described above, the present invention provides a simple robust measure of the bit error performance of a transmission system and a scheme for the dynamic self-optimisation of the system, which employs a feedback control loop that makes decisions in dependence on the calculated BER performance measure and attempts to minimise the BER. Thus, in contrast to some known schemes, the BER-based feedback technique may be retrofitted to legacy systems without requiring a factory-based set up or calibration procedure.

According to a fourth aspect of the present invention a transmission system comprises:

a transmitter module for transmitting a signal;

a receiver module for receiving the signal; and

a transmission link in which the signal propagates from the transmitter module to the receiver module;

wherein the receiver module comprises means for estimating the bit error performance of the transmission system from the received signal according to the method of the first aspect of the present invention, the system further comprising means to adjust a parameter of the transmission system in dependence on the measured BER.

Preferably, the receiver module comprises an FEC decoder module for decoding the received signal and identifying the bit errors to be counted. Again, in the absence of FEC, errors can be counted using the overhead bytes of the transmission type. For example, error detecting codes contained in the B1 and B2 bytes of the SDH/SONET overhead can be used to estimate the BER.

Preferably, the system parameter adjusting means comprises a control loop implementing a control algorithm. In this way feedback may be applied within the system. The control loop will preferably adjust the system parameter to minimise the measured BER.

The control loop will typically provide a control signal to a sub-unit of the transmitter and/or receiver module for adjusting a parameter. If the control signal is to be applied in the transmitter module, a separate return path may be provided from the receiver module to the transmitter module for transmitting this signal. Advantageously, however, the transmission link may be used as the return path for the control signal.

Preferably, the system parameter is controlled in the transmitter module. Examples of parameters that may be controlled in the transmitter module include: launch power, wavelength, pulse shape magnitude and phase of phase modulation applied by a phase modulator, or pre-dispersion applied by an adjustable dispersion element.

Alternatively, the system parameter may be adjusted in the receiver module. Examples of parameters that may be controlled in the receiver module include: decision timing and threshold point, centre wavelength and bandwidth of an optical filter, or post-dispersion applied by an adjustable dispersion element.

Advantageously, several system parameters may be adjusted either sequentially or concurrently. Performance of the system may be optimised with respect to each parameter independently or else globally, using a more sophisticated control algorithm.

The system of the present invention employs BER-based feedback applied via a high-level control loop to optimise system performance. System performance is optimised by minimising the BER as computed from a statistically reliable measure of BER performance. Feedback in conjunction with a control loop is self-regulating and so the bit error control system will operate faster at higher error rates and slower at lower error rates, thus automatically compensating for the needs of the system. Furthermore, the dynamic nature of the compensation allows the system to adapt as components in the transmitter and receiver module age, thereby extending their useful lifetime.

### BRIEF DESCRIPTION OF THE DRAWINGS

Examples of the present invention will now be described in detail with reference to the accompanying drawings, in which:

FIG. 1 shows receiver performance as a function of control parameter(s);

FIG. 2 illustrates the optimisation of transmitter launch power using a receiver BER feedback algorithm;

FIG. 3 illustrates transmitter and receiver parameter optimisation by BER feedback in a generalized transmission system;

FIG. 4 shows the probability mass function for the Poisson distribution with a mean number of errors 100;

FIG. 5 shows the cumulative Poisson distribution for the plot of FIG. 4;

FIG. 6 shows the variation in BER accuracy (to 95% confidence limits) with number of detected errors; and,

FIG. 7 shows the time required to measure BER to an accuracy of ±5% within confidence levels of 68%, 95% and 99.7%.

### DETAILED DESCRIPTION

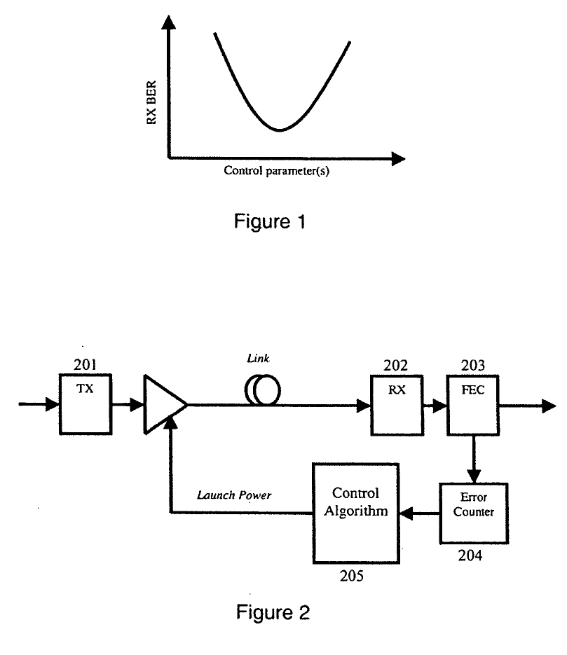

BER measurement is now generally available as a by-product of forward error correction (FEC) in transponder design, and control loops may be designed to utilise this information to optimise transmission. FIG. 1 illustrates a typical optimisation curve for BER at the receiver (Rx) end as a function of the parameter under control. By appropriate adjustment, the system may be tuned to a local minimum in the BER of the received signal.

Typically, BER is derived from an error counter register that may periodically be read and re-set. A simplistic algorithm may take this error counter reading at equal time intervals and derive a BER from the relationship BER=Number of Errors/Data Rate. For example, 10 errors in a 1 second period equates to a 1×10⁻⁹ BER for a 10 Gb/s data rate.

The algorithm may then adjust some parameter of the transmission system to try to improve the BER using a classical dither algorithm. An example of a typical simple algorithm is as follows:

Start loop:

Increase Launch power

Wait 1 second

Read errors, calculate BER1

Decrease Launch power

Wait 1 second

Read errors, calculate BER2

if BER1>BER2 Decrease Launch power

if BER1<BER2 Increase Launch power

Repeat loop

This algorithm will increase and decrease launch light level as appropriate to minimise the measured BER, and is commonly called automatic channel pre-emphasis. A schematic of a system for implementing this technique is shown in FIG. 2. Signals generated by the control algorithm are used to control an amplifier at the transmission (Tx) end of the system, thereby determining the level of power launched into the link.

Although a system employing the simple algorithm is capable of achieving the desired result, it is also possible that there may be inaccurate BER estimations under circumstances of very low BER. For example, statistically the first BER measured (BER1) may be error free for several iterations, whereas the second BER measured (BER2) and could have the odd error in each cycle. This would lead to a random walk-like behaviour, which would limit convergence by the control loop and tend to de-optimise the system. Furthermore, at high error rates, the loop will not be updating sufficiently fast to keep track of system fluctuations.

Common FEC implementations used for a 10 Gb/s data rate are able to work at 1×10⁻³ BER and an arbitrary 1-second wait period would be substantially longer than the error interval (an error would on average occur every 0.1 μS). However, if the error rate were 1×10⁻¹² BER, an arbitrary 1-second wait period would be substantially shorter than the error interval (an error would occur every 100 seconds). Statistically, the measurement of a single error is not sufficiently significant for predicting an error rate, and both of the above scenarios are possible in real system operation.

In order to mitigate the problems of known techniques, such as described above, a new algorithm is proposed that effectively applies consistent statistics to all error rate measurements. Instead of waiting a specified period before reading an error counter, the error counter is read continuously in order to determine the time period for a specified number of errors to be detected. This has the effect of giving a BER measurement with a well-defined confidence level and accuracy.

FIG. 2 shows a simple feedback system comprising a transmitter 201, receiver 202, FEC decoder 203, error counter 204 and control algorithm 205. A suitable algorithm implementing the proposed technique for the feedback system of FIG. 2, is as follows:

Start loop:

Increase Launch power

Start timer

Wait for error counter to read 100

Read timer, calculate BER1

Decrease Launch power

Start timer

Wait for error counter to read 100

Read timer, calculate BER2

if BER1>BER2 Decrease Launch power

if BER1<BER2 Increase Launch power

Repeat loop

Now, if the error rate is high, the algorithm will operate quickly. Conversely, if the error rate is very low, the algorithm will operate very slowly. Nevertheless, irrespective of the speed of BER determination, the measure of BER on which actions are based will always have the same statistical significance. For example, counting successively to 100 errors yields a BER with a 95 percent confidence interval, accurate to +/−20%. The accuracy is determined by the formula 100*2/√N where N is the number of errors counted.

Thus, the scheme is automatically self-regulating, taking account of the prevailing conditions. Statistically, decisions made on the basis of the BER estimation will always have consistent validity.

The specific number of errors counted, N, is directly related to the accuracy required. Typically 100 is chosen and has been found to work with sufficient reliability. Of course, N=1000 would be even better, whereas N=10 would be worse. The appropriate value to be used depends on the size of the steps to be used, and the loop jitter and speed of response desired.

The BER estimation technique can be applied to all control algorithms that use BER as a feedback mechanism. For illustration purposes, the control algorithm described above is a classical dither loop. Of course, there exist more elegant methods, such as “Nelder-Mead Simplex”, which is geared to the simultaneously control of multiple parameters from a single measurement variable. Other examples of algorithms which attempt to find a global minimum are “Simulated Annealing” and “Genetic Algorithms”. However, whichever control algorithm is to be used, the crucial element is the BER estimation technique to be applied to it.

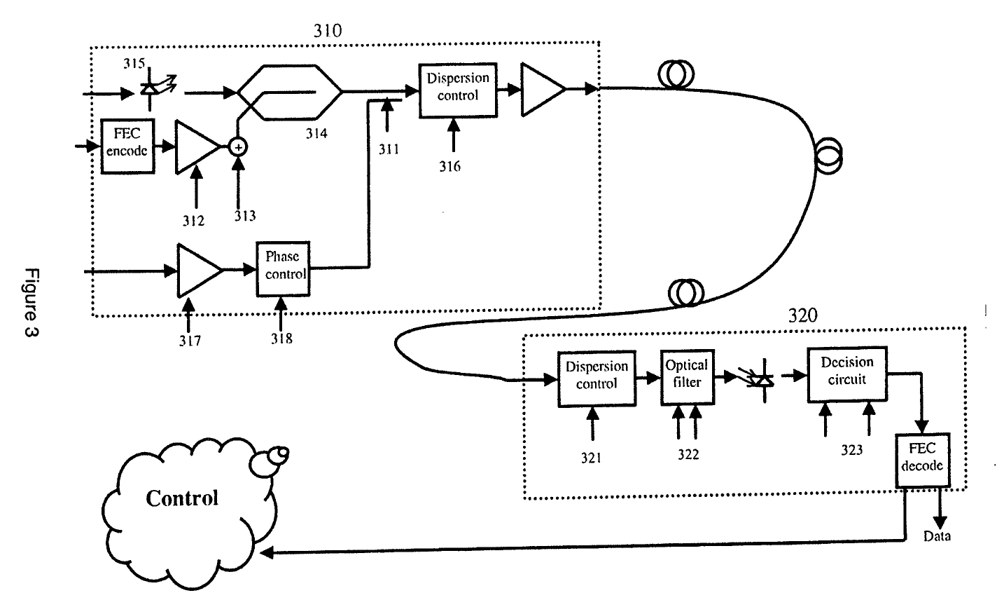

Thus far, application of the feedback control technique has been restricted to an algorithm for controlling channel launch power, as this is frequently a key parameter in a transmission system having non-linear characteristics. However, there exists a whole array of other parameters that may be controlled in a similar manner for optimal system performance. Several such parameters will now be described with reference to FIG. 3, which illustrates a generalized optical transmission system having a transmitter (Tx) module 310 and a receiver (Rx) module 320 and a transmission link in which signals propagate from the transmitter 310 to the receiver 320. BER information is derived from an FEC decoding unit 324 in the receiver module 320 and is used for feedback control of particular sub-units within the transmitter and/or receiver module(s).

1) Transmitter Phase Modulation Control (Magnitude and Phase):

As shown in FIG. 3, a phase modulator component 311 may be used to pre-chirp a signal prior to its amplification and launch into the transmission link. The magnitude and phase of the synchronous clock signal applied to the phase modulator may be controlled independently by gain control 317 and phase control 318. Such phase modulation is often applied to RZ format modulation and is commonly known as CRZ (chirped RZ). The modulation is usually sinusoidal and can overcome non-linear or chromatic dispersion effects in the link

2) Transmitter Modulation Parameters (Pulse Shape and Extinction Ratio):

As described in the Applicant's co-pending application (Agent's reference PJF01891GB), it is possible to optimise transmitted pulse shape for best received BER by appropriate adjustment modulator drive and bias voltages. As such, BER-based feedback according to the present invention may be applied to this optimisation. As shown in FIG. 3, the feedback is applied to the gain/duty cycle 312 and bias controlling units 313 of the Mach-Zehnder (MZ) modulator 314. The technique is particularly applicable to electrically generated RZ format, but may be extended to other modulation formats, including CSRZ, Duobinary, DPSK, NRZ, Pilot-Carrier, directly-modulated sources and any other scheme characterised by a set of device control parameters.

3) Transmitter Source Wavelength:

Within a system there will generally be a wavelength that realises an optimal BER. For example, in a dense-WDM system, the ideal location is a compromise between minimising spectral overlap by adjacent channels and four wave mixing. Component ageing and drift will tend to corrupt this tuning position. However, correct operation may be assured by the use of a control loop with BER feedback to control the transmitter source (e.g. CW laser 315) and thereby maintain the required DWDM wavelengths. Spurious spectral components arising from non-linear effects, such as four-wave mixing, can also be avoided by using this technique.

4) Receiver Decision Point (Threshold and Timing Point):

As shown in FIG. 3, a binary decision timing and threshold point unit 323 is provided within the receiver module 320. The setting of these parameters may also be optimised by feedback for best overall BER.

5) Receiver Optical Filter Centre Wavelength:

As described in the Applicant's co-pending application (Agent's reference PJF01870GB), a tuneable filter 322 may be employed in the receiver module and tuned for optimal signal reception in a WDM transmission system. BER-based feedback may be used to control the centre wavelength characteristic of the filter 322.

6) Receiver Optical Filter Bandwidth:

Where control is available, the bandwidth of the receiver module filter can also be optimised to intercept a particular signal and/or to reject unwanted amplified spontaneous emission (ASE) or adjacent channels. BER-based feedback may be applied to this.

7) Receiver (or Transmitter) Optical Dispersion Compensation:

Typically, a transmission link will require dispersion compensation to be applied, according to wavelength, transmission fibre type and non-linear transmission effects within the system. FIG. 3 shows a receiver dispersion compensation module 321 and a transmitter dispersion compensation module 316. Conventionally, fixed spools of dispersion-compensated fibre (DCF) are chosen for a particular wavelength, once a set of optimisation tests have been completed. Active components are available to do the same and BER may be used as the feedback control mechanism. Suitable active elements include tuneable fibre-Bragg gratings and tuneable etalons.

It will now be apparent that there exists a range of possible system parameters that may be adjusted either individually or as an ensemble. In all cases, the general approach is to find an optimisation curve for the relevant system parameter, similar to that shown in FIG. 1. The overall control system may be based on a combination of techniques. For example, a combination of BER feedback (using the statistically correct measure) and parameter dither (or another optimising algorithm, such as the Nelder-Mead Simplex algorithm). The result is a system that will reach an operating point having increased margins and will also combat ageing and drift by dynamically adjusting in response to the changing parameter values.

As is clear from the foregoing discussion, the key element of the invention is a statistically reliable measure of system BER performance. Therefore, the determination of the BER measurement accuracy is now considered in more detail. The relative BER measurement accuracy depends on the number of errors detected, irrespective of the time required for the measurement. A formula will be derived which allows the accuracy of the BER measurements to be estimated assuming a Poisson process for the error arrival times. For typical scenarios, a Poisson distribution may be approximated to a Gaussian distribution to a good accuracy. As an example, if measurements are made until 100 errors are detected, then the measured BER will be accurate to within ±20% (or 0.08 of a decade to within 95% confidence limits, irrespective of the absolute value of the BER.

If a Poisson process is assumed for the bit error arrival times, then the probability f(k) of k errors occurring during a period t is given by

$$f ( k ) = \frac{{N}^{k}}{k !} {ⅇ}^{- N} \qquad ( 1 )$$

where N is the mean number of errors expected over a period t. If B is the bit rate and \overline{r} is the mean bit error ratio, then N is given by
N=B\overline{r}t (2)

The probability that the number of errors in time t is less than n is given by the corresponding cumulative distribution

$$F ( n ) = {ⅇ}^{- N} {\sum }_{k = 0}^{n} \frac{{N}^{k}}{k !} \qquad ( 3 )$$

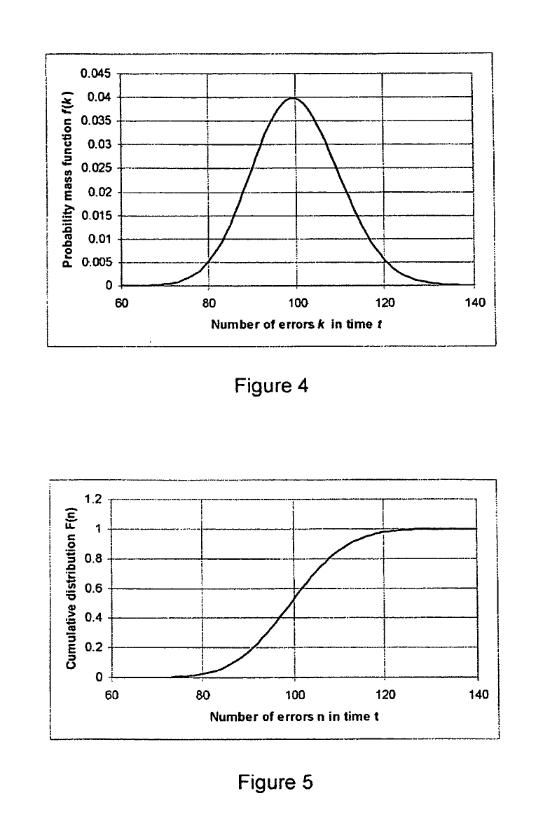

As an example, if the bit rate is 10.7 Gb/s and the mean bit error ratio is 10⁻⁸, then N=100 errors are to be expected over a period of 0.935 seconds. The probability, f(k), of k errors occurring over this time is plotted in FIG. 4.

The error rate r (as opposed to the mean value \overline{r}) corresponding to k errors over time t is then given according to k=Brt. The cumulative distribution is shown in FIG. 5, from which the confidence limits can be extracted. In this example, for instance, the number of errors will fall between 80 and 120 to within 95% confidence limits. More precisely, to determine the confidence limits for the BER, the Tchebycheff inequality is firstly used to determine how close the measured number of errors k is to the expected number N, as follows:
k−mσ<N<k+mσ (4)
where σ is the standard deviation of the distribution and m is the number of standard deviations from the mean required for the desired confidence interval (95% confidence limits correspond to m=2). Since the measurement time and bit rate are known, the inequality may be written as:
Brt−m\sqrt{Brt}<N<Brt+m\sqrt{Brt} (5)
where the standard deviation of the Poisson distribution is given by σ=\sqrt{N} and the best estimate of this is \sqrt{k}. On re-arranging, equation (5) becomes:

$$r - m \sqrt{\frac{r}{Bt}} < \frac{N}{Bt} < r + m \sqrt{\frac{r}{Bt}} . \qquad ( 6 )$$

From this it is clear that the mean BER is given by:

$$\vec{r} = r \pm m \sqrt{\frac{r}{Bt}} \qquad ( 7 )$$

to within ±mσ limits. The measurement error therefore varies with time according to 1/\sqrt{t}. Thus, if the ±mσ limits are to be within X % of the true rate, the requirement is that

$$m \sqrt{\frac{r}{Bt}} / r = \pm x$$

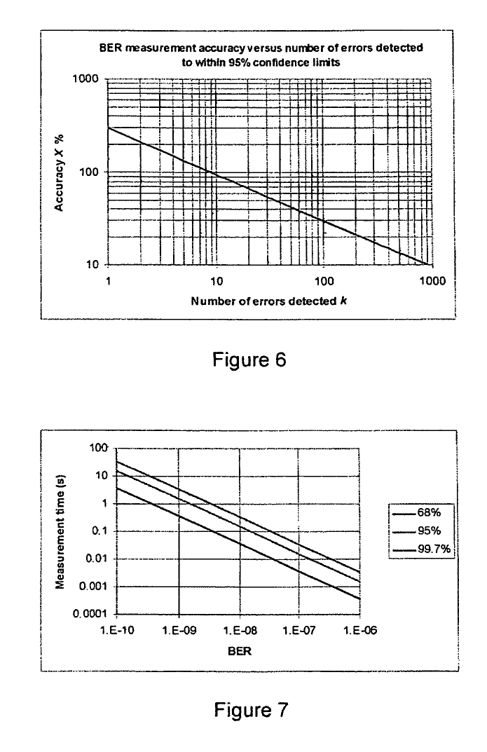

or
X=±100m/\sqrt{k} (8)
where x=X/100. As an example, if the number of measured errors k=Brt=100 then, for ±2σ limits (95% confidence), the accuracy of the determination is within 20%, or 0.08 of a decade. A plot of accuracy versus number of detected errors is shown in FIG. 6 for 95% confidence limits.

Using equation (8), and the relation k=Brt, the time required to measure the BER to within X % of the true value with ±mσ confidence limits is given by:

$$t = \frac{1}{Br} {( \frac{m}{x} )}^{2} \qquad ( 9 )$$

The graph of FIG. 7 shows the measurement times required to achieve a BER measurement to within ±5% at three different confidence intervals for a 10.7 Gb/s bit rate.

With reference to FIG. 4, it is apparent that the Poisson distribution approximates well to a Gaussian distribution, provided the lower 3σ limit is well above zero errors. The confidence limits can then be taken from the Gaussian distribution, in which case the ±σ, ±2σ and ±3σ limits correspond to 68%, 95% and 99.7% confidence levels, respectively.

1. A method for estimating the bit error performance of a transmission system through which a signal is propagating comprising the steps of:
counting a predetermined number of bit errors occurring consecutively in the signal;
concurrently recording a time period during which the predetermined number of bit errors occurs; and,
computing a measured bit error rate (BER) in dependence on the predetermined number of bit errors and the time period.

2. A method according to claim 1, in which the predetermined number of bit errors is at least 10.

3. A method according to claim 1, in which the predetermined number of bit errors is at least 100.

4. A method according to claim 1, in which the bit errors are counted by forward error correction decoding of the received signal.

5. A method according to claim 1, in which the bit errors are counted using the overhead bytes of the transmission type.

6. A computer program product comprising computer executable code for implementing the method of claim 1.

7. A method for controlling the bit error performance of a transmission system through which a signal is propagating comprising the steps of:
counting a predetermined number of bit errors occurring consecutively in the signal;
concurrently recording a time period during which the predetermined number of bit errors occurs;
computing a measured bit error rate (BER) in dependence on the predetermined number of bit errors and the time period; and,
adjusting a parameter of the transmission system in dependence on the measured BER.

8. A method according to claim 7, in which the transmission system parameter is adjusted to reduced the measured BER.

9. A method according to claim 7, further comprising the step of providing a parameter control system adjusting a parameter of the transmission system in dependence on the measured BER.

10. A computer program product comprising computer executable code for implementing the method of claim 7

11. A transmission system, comprising:
a transmitter module for transmitting a signal;
a receiver module for receiving the signal; and,
a transmission link in which the signal propagates from the transmitter module to the receiver module;
wherein the receiver module comprises means for estimating the bit error performance of the transmission system from the received signal according to the method of claim 1, the system further comprising means to adjust a parameter of the transmission system in dependence on the measured bit error rate.

12. A transmission system according to claim 10, wherein the receiver module comprises a forward error correction decoder module for decoding the received signal and identifying the bits to be counted.

13. A transmission system according to claim 10, wherein the receiver module comprises means for counting the bit errors using the overhead bytes of the transmission type.

14. A transmission system according to claim 10, wherein the system parameter adjusting means comprises a control loop implementing a control algorithm.

15. A transmission system according to claim 13, wherein the control loop adjusts the system parameter to minimise the measured BER.

16. A transmission system according to claim 13, wherein the control loop provides a control signal to be applied in the transmitter module.

17. A transmission system according to claim 15, wherein the control signal propagates along the transmission link.

18. A transmission system according to claim 10, wherein the system parameter is controlled in the transmitter module.

19. A transmission system according to claim 10, wherein the system parameter is controlled in the receiver module.

20. A transmission system according to claim 10, further comprising means to adjust a plurality of parameters of the transmission system.
